(19) United States
(12) Patent Application Publication
(10) Pub. No.: US 2012/0086217 A1
(43) Pub. Date: Apr. 12, 2012

(54) Power Generation Apparatus

(75) Inventors: Vincent Benda, Graz (AT); Robert Fischer, Graz (AT); Bernhard Graf, Graz (AT); Christian Hubmann, Graz (AT); Ralf Kunzemann, St. Radegund (AT); Helmut List, Graz (AT); Günter Hohenberg, Graz (AT); Josef Wolkerstorfer, Graz (AT)

(73) Assignee: AVL LIST GMBH, Graz (AT)

(21) Appl. No.: 13/138,347

(22) PCT Filed: Feb. 4, 2010
(86) PCT No.: PCT/EP2010/051357

§ 371 Date: Dec. 14, 2011

(30) Foreign Application Priority Data
Feb. 5, 2009 (AT) A 201/2009
Apr. 2, 2009 (AT) A 524/2009

(51) Int. Cl. H02K 7/18

(52) U.S. Cl. 290/1 A; 180/65.21; 903/902

(57) ABSTRACT

The invention relates to a power generation apparatus (1), in particular for expanding the range of an electrically operated vehicle, having an internal combustion engine (5) and a generator (6), which is situated coaxially to the output shaft (7) of the internal combustion engine (5), internal combustion engine (5) and generator (6) being situated in a housing (2, 3) through which cooling air flows. In order to increase the power density, minimize the noise emission, and allow a compact construction, it is provided that internal combustion engine (5) and generator (6) are implemented as a unit (10) and are situated in a substantially tubular cooling chamber (4) formed by an inner housing, an intake air duct (8) opening into the cooling chamber (5) on the side of the generator (6), preferably approximately in the area of the output shaft axis (7′), and an exhaust air duct (9) originating from the cooling chamber (4) on the side of the internal combustion engine (5), preferably in the area of the output shaft axis (7′), and the internal combustion engine-generator unit (10) being mounted in the housing (2, 3) via noise-damping engine bearings.

The invention relates to a power generation apparatus, in particular for expanding the range of an electrically operated vehicle, having an internal combustion engine and a generator, which is situated coaxially to the output shaft of the internal combustion engine, internal combustion engine and generator being situated in a housing through which cooling air flows.

An autonomously operable portable power generation apparatus is known from US 2005/0279542 A1, which is used for the purpose of expanding the range of an electric vehicle. The power generation apparatus has an internal combustion engine and a generator situated coaxially thereto, internal combustion engine and generator being situated in a common housing. The common housing, which is divided by a partition wall into two areas, has cooling air flowing through it, the cooling air flowing into the housing in the area of the generator and flowing back out of the housing at the end of the housing on the internal combustion engine side. The rotor of the generator and the output shaft of the internal combustion engine have fan blades to convey the cooling air.

U.S. Pat. No. 7,049,707 B2 discloses a power generation assembly, comprising an internal combustion engine and a generator, which are connected to one another via a common shaft. Internal combustion engine and generator are situated in a common housing, which has entry openings for cooling air on the side of the generator and on the side of the internal combustion engine, the cooling air being conveyed by fan rotors.

Furthermore, a machine apparatus comprising a rotary piston internal combustion engine and a rotary piston compressor, as well as a generator, is described in DE 39 30 901 A1. The compressor and the power generator are driven by the internal combustion engine via belt drives. Furthermore, the internal combustion engine drives a fan wheel via a universal joint and a longitudinally-displaceable drive shaft, which is non-rotatable per se. The internal combustion engine can be cooled via a radiator located in the stream of the fan wheel. The machine apparatus is intended as a transportable device for use in case of catastrophe or for military purposes.

Known power generation apparatuses have the disadvantage that they are relatively cumbersome and heavy and occupy a large amount of installation space. In spite of known efforts to achieve noise reduction through noise-damping encapsulations or the like, typical power generation apparatuses have a relatively high operating noise. Therefore, typical power generation apparatuses have only limited suitability for use in motor vehicles, in particular in electric motor vehicles.

Power generation apparatuses which are used as so-called range extenders for electric vehicles are to be able to be operated with as little noise as possible, are to occupy little installation space, and are to have a low weight, and nonetheless have a high power density. These requirements are only partially fulfilled by known power generation apparatuses.

The object of the invention is therefore to develop a power generation apparatus which fulfills the mentioned requirements and has a high power density with low operating noise. In addition, the power generation apparatus is to be implemented compactly and is to have a low weight, so that it can be integrated in a simple way in typical electric vehicle concepts with as little additional expenditure as possible.

This is achieved according to the invention in that internal combustion engine and generator are implemented as a unit and are situated in a substantially tubular cooling chamber of the housing, formed by an inner housing, an intake air duct opening into the cooling chamber on the side of the generator, preferably approximately in the area of the output shaft axis, and an exhaust air duct originating from the cooling chamber on the side of the internal combustion engine, preferably in the area of the output shaft axis, and the internal combustion engine-generator unit being mounted in the housing via a noise-damping engine bearings.

The internal combustion engine-generator unit is therefore enclosed by an airflow sheath, which has an advantageous effect on the noise emission.

In order to further minimize the operating noise and ensure sufficient cooling of the unit, it is advantageous if the internal combustion engine is water-cooled and at least one air/water heat exchanger is situated in the cooling chamber—preferably, in relation to the output shaft axis—air/water heat exchangers are situated on both sides of the internal combustion engine, the internal combustion engine preferably being implemented as a rotary piston engine.

An extraordinarily compact construction may be achieved if the intake air duct, the cooling chamber, and the exhaust air duct are situated in an “S” shape—viewed in horizontal projection.

To implement a sufficient cooling air throughput, it is provided that—in relation to the airflow—a fan is situated upstream from the generator in the cooling chamber, whose rotor is situated coaxially with the output shaft axis, an intake nozzle of the internal combustion engine preferably being situated in the cooling chamber downstream from the exit of the fan—in relation to the airflow. In this way, because the intake nozzle is situated downstream from the fan rotor, already pre-compressed air is sucked in, which has an advantageous effect on the engine performance.

An extraordinarily compact and low-noise concept may be achieved if an exhaust gas duct of the internal combustion engine opens into the exhaust air duct, preferably in the area of the output shaft axis, and preferably downstream from the air/water heat exchanger. Because the exhaust gases are injected into the cooling air, the noise emission may be reduced further.

An extraordinarily small installation volume and a minimum number of components may be achieved if a force-providing part of the internal combustion engine and a power-generating part of the generator, in particular the rotor of the generator, have a common shaft, it being particularly advantageous if the rotor of the generator is connected to a first balancing mass for mass balancing or forms a unit therewith. Furthermore, it can be provided in the scope of the invention that a housing of the generator and an output-side housing part of the internal combustion engine form a unit, and are preferably implemented integrally. This allows a very compact and low-noise embodiment.

Furthermore, to save components and installation space, it can be provided in a very low-noise concept that a fuel tank, which is preferably integrated in the housing, is situated at least on one side of the cooling chamber, the intake air duct, and the exhaust air duct.

In a further embodiment of the invention, it can be provided that a fuel tank, which is preferably integrated in the housing, is situated on at least on one side of the cooling chamber, the intake air duct, and the exhaust air duct. The power generation apparatus therefore forms a closed structural module together with the fuel tank and can also be conceived as a replaceable module, which can be inserted or removed in a predetermined vehicle space as needed.

A space-saving design may be implemented if a first balancing mass is situated on the rotor of the generator, which is preferably implemented integrally with the rotor, the drive shaft preferably having a second balancing mass on a second end facing away from the first end.

Because the first balancing mass is integrated in the rotor of the generator, the power generation apparatus can be implemented very compactly and having low weight.

An extremely compact and low-noise concept may be achieved if both the internal combustion engine and also the generator are water-cooled, the housing of the internal combustion engine and the housing of the generator having integrated cooling ducts, the cooling ducts of the internal combustion engine and the cooling ducts of the generator having a flow connection to one another without lines. It is particularly advantageous if the housing of the generator directly adjoins the housing of the internal combustion engine, the housing of the generator preferably being implemented integrally with the housing of the internal combustion engine.

A particularly compact and lightweight construction is made possible if an oil pump is situated in the area of the second end of the drive shaft, whose rotor is rotationally connected to the drive shaft, the oil pump preferably being situated between the internal combustion engine and the second balancing mass.

The invention is explained in greater detail hereafter on the basis of the figures.

In the figures:

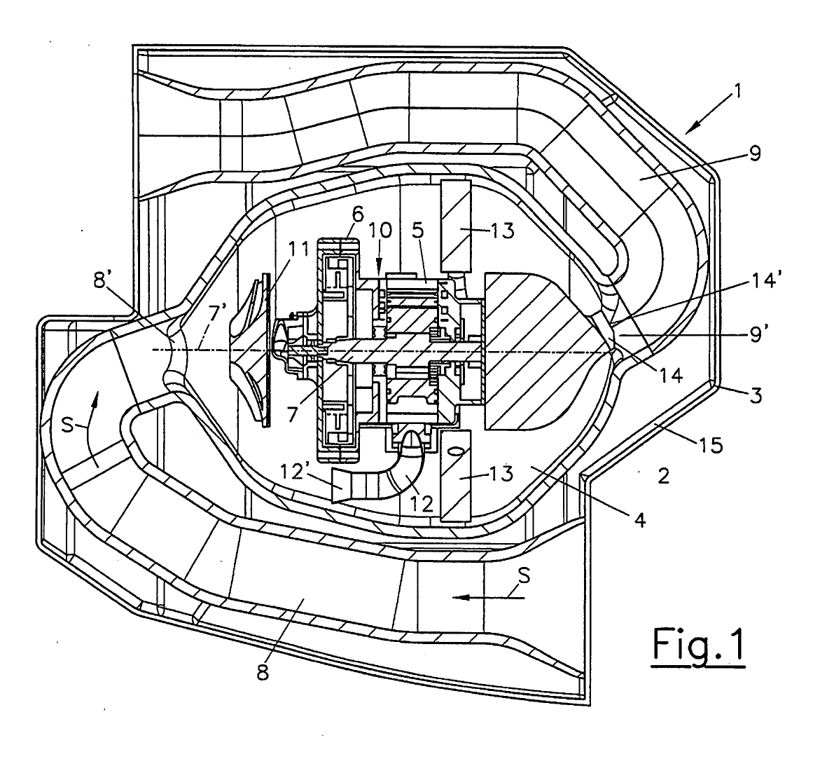

FIG. 1 shows the power generation apparatus according to the invention in a longitudinal section; and

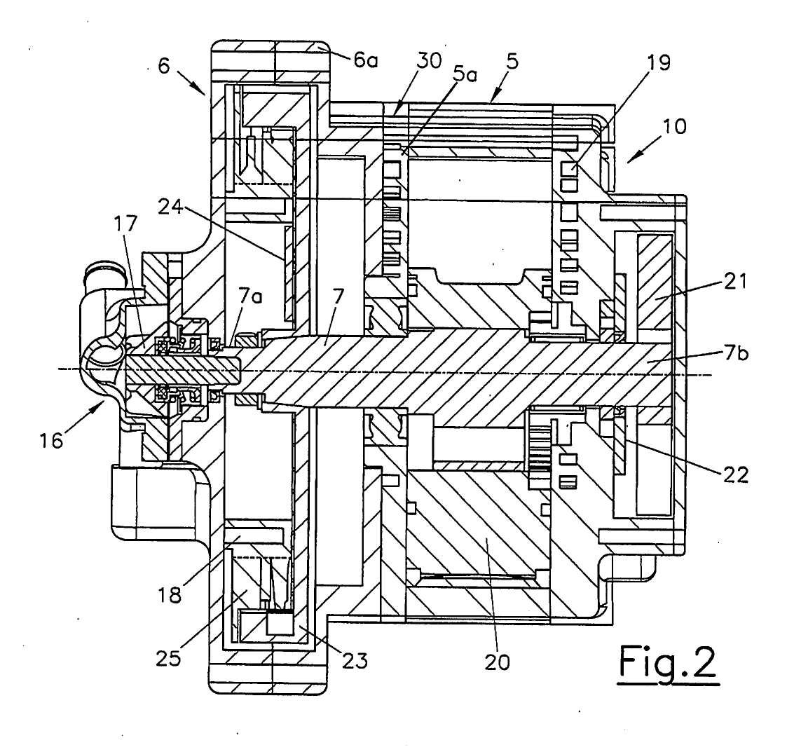

FIG. 2 shows an internal combustion engine-generator unit of the power generation apparatus in a longitudinal section.

FIG. 1 shows a power generation apparatus 1 having an inner housing 2 and an outer housing 3. The inner housing 2 forms a cooling chamber 4, in which an internal combustion engine 5 and a generator 6 are situated, the generator 6 being rotationally connected to the output shaft 7 of the internal combustion engine 5. In the exemplary embodiment, the internal combustion engine 5 is formed by a rotary piston engine. The cooling chamber 4 is implemented as essentially tubular, an intake air duct 8 opening into the cooling chamber 4 approximately in the area of the output shaft axis 7′ on the generator side. An exhaust air duct 9 originates from the cooling chamber 4 in the area of the output shaft axis 7′ on the side of the internal combustion engine 5. Intake air duct 8, cooling chamber 4, and exhaust air duct 9 form the shape of an “S” in the sectional view shown in FIG. 1 or in a horizontal projection of the power generation apparatus, so that extremely compact packing can be achieved.

The internal combustion engine-generator unit 10 formed by internal combustion engine 5 and generator 6 is supported via a vibration-damping engine bearings in the inner housing 2. A fan rotor 11, which is driven by the output shaft 7, is situated on the side of the mouth 8′ of the intake air line 8 into the cooling chamber 4. An air stream is generated in accordance with the arrows S in the intake air duct 8, cooling chamber 4, and in the exhaust air duct 9 by the fan rotor 11, the internal combustion engine-generator unit 10 having flow around it in the form of a sheath flow.

The intake opening 12′ of an intake line 12 of the internal combustion engine 5 is situated downstream from the fan rotor 11. Air which is already precompressed by the fan rotor 11 can thus be sucked in by the internal combustion engine 5, which has an advantageous effect on the engine performance.

The internal combustion engine 5 is implemented as water-cooled. Air/water heat exchangers 13, which the cooling air S flows against, are situated on both sides of the output shaft axis 7 in the cooling chamber 4 for optimum cooling of the internal combustion engine 5. The mouth 14′ of an exhaust gas line 14 of the internal combustion engine 5 is situated in the area of the exit 9′ of the exit line 9 from the cooling chamber 4, so that the exhaust gases are introduced directly into the cooling air stream S and mixed with the cooling air. This allows cooling of the exhaust gases, on the one hand, and effective reduction of the noise emission, on the other hand.

A fuel tank 15 is integrated in the power generation apparatus 1, at least on one side of the cooling chamber 4, in the outer housing 3 of the power generation apparatus 1.

As is recognizable from FIG. 2, a coolant pump 16, whose rotor 17 is rotationally connected to the output shaft 7, is integrated in the internal combustion engine-generator unit 10 in the area of a first end 7a of the output shaft 7. The coolant pump 16 is situated on the side of the internal combustion engine-generator unit 10 facing toward the mouth 8′ of the fresh air line 8. The coolant water reaches water chambers 18 (only partially visible in FIG. 2) of the generator 6 and 19 of the internal combustion engine 5 from the coolant pump 16 and is then supplied to the air/water heat exchangers 13. A housing part 5a of the internal combustion engine 1 and a housing 6a of the generator 6 directly adjoin one another and have a common cooling system 30, the cooling ducts 18, 19 of the generator 6 and the internal combustion engine 5 having a direct flow connection to one another without separate lines.

The internal combustion engine-generator unit 10 is fully balanced per se, the imbalance of the eccentric output shaft 7 being compensated for by a first balancing mass 24 integrated in the rotor 23 of the generator 6, and by a second balancing mass 21 on the side of the oil pump 22, which is rotationally connected to the output shaft 7 in the area of a second end 7b. The rotary piston of the internal combustion engine 5 is indicated by reference sign 20. The oil pump 22 is situated on the end of the output shaft 7 opposite to the coolant pump 16.

Reference sign 25 indicates the stator of the generator 6.

The extremely compact power generation apparatus 1 is constructed as a module and can therefore be inserted as needed into corresponding spaces of an electric vehicle in order to expand its range. The compact construction and the high power density allow the power generation apparatus to be used as a range extender in already existing concepts of electric vehicles without substantially reducing the useful space and/or substantially increasing the overall weight.

1-19. (canceled)

20. A power generation apparatus for expanding the range of an electrically operated vehicle, having an internal combustion engine and a generator, which is situated coaxially to the output shaft of the internal combustion engine, internal combustion engine and generator being situated in a housing, through which cooling air flows, wherein internal combustion engine and generator are implemented as a unit and are situated in a substantially tubular cooling chamber formed by an inner housing, an intake air duct opening into the cooling chamber on the side of the generator, and an exhaust air duct originating from the cooling chamber on the side of the internal combustion engine, and the internal combustion engine-generator unit being mounted in the housing via engine bearings.

21. The power generation apparatus according to claim 20, wherein the intake air duct opens into the cooling chamber approximately in the area of the output shaft axis.

22. The power generation apparatus according to claim 20, wherein the exhaust air duct extends from the cooling chamber in the area of the output shaft axis.

23. The power generation apparatus according to claim 20, wherein the internal combustion engine is water-cooled and at least one air/water heat exchanger is situated in the cooling chamber.

24. The power generation apparatus according to claim 23, wherein—in relation to the output shaft axis—air/water heat exchangers are situated on both sides of the internal combustion engine.

25. The power generation apparatus according to claim 20, wherein the intake air duct, the cooling chamber, and the exhaust air duct are situated in an “S” shape—viewed in horizontal projection.

26. The power generation apparatus according to claim 20, wherein—in relation to the air flow—a fan is situated upstream from the generator in the cooling chamber.

27. The power generation apparatus according to claim 26, wherein a fan rotor of the fan is situated coaxially with the output shaft axis.

28. The power generation apparatus according to claim 26, wherein—in relation to the air flow—an intake opening of an intake line of the internal combustion engine is situated in the cooling chamber downstream from the exit of the fan.

29. The power generation apparatus according to claim 20, wherein an exhaust gas line of the internal combustion engine opens into the exhaust air duct downstream from the air/water heat exchanger.

30. The power generation apparatus according to claim 29, wherein the exhaust gas line opens into the exhaust air duct in the area of the output shaft axis.

31. The power generation apparatus according to claim 20, wherein the internal combustion engine comprises a rotary piston engine.

32. The power generation apparatus according to claim 20, wherein a force-providing part of the internal combustion engine and a power-generating part of the generator, have a common shaft.

33. The power generation apparatus according to claim 32, wherein the power-generating part of the generator is a rotor of the generator.

34. The power generation apparatus according to claim 20, wherein a rotor of the generator is connected to a first balancing mass for the mass balancing or forms a unit therewith.

35. The power generation apparatus according to claim 20, wherein a housing of the generator and an output-side housing part of the internal combustion engine form a one-piece unit.

36. The power generation apparatus according to claim 35, wherein the housing and the output-side housing part of the internal combustion engine have a common cooling system.

37. The power generation apparatus according to claim 20, wherein a fuel tank is situated at least on one side of the cooling chamber, the intake air duct, and the exhaust air duct.

38. The power generation apparatus according to claim 37, wherein the fuel tank is integrated in the housing.

39. The power generation apparatus according to claim 20, wherein it is formed by a portable and replaceable module and the module has docking units and/or electrical interfaces for connection to and for installation in an electric vehicle.

40. The power generation apparatus according to claim 20, wherein the internal construction engine-generator unit is mounted in the housing via noise-damping engine bearings.

41. A power generation apparatus for expanding the range of an electrically operated motor vehicle having an internal combustion engine and a generator situated coaxially therewith, having a rotor rotationally connected to the drive shaft, at least one balancing mass which rotates therewith being situated on the drive shaft of the internal combustion engine, wherein a first balancing mass is situated on the rotor of the generator.

42. The power generation apparatus according to claim 41, wherein the first balancing mass is one-piece with the rotor.

43. The power generation apparatus according to claim 41, wherein the rotor is situated on a first end of the drive shaft, wherein the drive shaft has a second balancing mass on a second end facing away from the first end.

44. The power generation apparatus according to claim 41, wherein a coolant pump is situated adjoining the generator in the area of the first end of the drive shaft, whose rotor is rotationally connected to the drive shaft.

45. The power generation apparatus according to claim 41, wherein an oil pump is situated in the area of the second end of the drive shaft, whose rotor is rotationally connected to the drive shaft.

46. The power generation apparatus according to claim 45, wherein the oil pump is situated between the internal combustion engine and the second balancing mass.

47. The power generation apparatus according to claim 41, wherein both the internal combustion engine and also the generator are water-cooled, the housing of the internal combustion engine and the housing of the generator having integrated cooling ducts, the cooling ducts of the internal combustion engine and the cooling ducts of the generator having a flow connection to one another without lines.

48. The power generation apparatus according to claim 41, wherein the housing of the generator directly adjoins the housing of the internal combustion engine.

49. The power generation apparatus according to claim 48, wherein the housing of the generator is one-piece with the housing of the internal combustion engine.

50. The power generation apparatus according to claim 41, wherein the internal combustion engine consists of a rotary piston internal combustion engine.
